(19) United States
(12) Patent Application Publication
(10) Pub. No.: US 2011/0302265 A1
(43) Pub. Date: Dec. 8, 2011

(54) LEADER ARBITRATION FOR PROVISIONING SERVICES

(75) Inventors: Jaskaran Singh, Bellevue, WA (US); Mark Coburn, Snohomish, WA (US); Rui Chen, Bellevue, WA (US)

(73) Assignee: MICROSOFT CORPORATION, Redmond, WA (US)

(21) Appl. No.: 12/792,896

(22) Filed: Jun. 3, 2010

(51) Int. Cl. G06F 15/16

(52) U.S. Cl. 709/208; 709/226

(57) ABSTRACT

Single leader provisioning is enabled through a locking mechanism in a directory service environment. A service running in a domain is enabled to take leader role by writing to a shared file maintained at a relative identity (RID) master server. The service taking the leader role is further enabled to extend its role by rewriting to the shared file periodically. Other services may check the file also periodically and remain passive as long as a service has currently the leader role. If the leader service is down and fails to extend its role, another service can take over by writing to the shared file ensuring a single leader in the provisioning service.

### BACKGROUND

Networked systems have evolved from a few computers exchanging files to complicated multi-purpose systems. A wide variety and size of networks coupling various computing devices perform numerous tasks covering daily lives of people. A typical network may include a number of wired/wireless sub-networks, a few to a large number of servers/clients, partitions, subnets, and many more aspects. As the number and variety of networked systems increased the need to provide a standardized management strategy resulted in development of various approaches.

Directory services are a powerful tool in network management allowing administrators to assign policies, deploy software, and apply critical updates to an organization. Differently from directories, directory services are both the information source and the functionality that makes the information available to users. A directory service stores information and settings associated with objects such as servers, users, and other resources in a central database. The information can be used for identification when communicating with network resources, but also as the definition of where an object fits into an overall hierarchical scheme. Directory services may be implemented in networks varying from a small installation with a few computers, users and printers to tens of thousands of users, many different domains and large server farms spanning many geographical locations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a locking mechanism for provisioning services in a directory service environment. According to some embodiments, a service running in a domain may be enabled to take leader role by writing to a shared file maintained at a relative identity (RID) master server or another singleton role such as Schema Master, domain naming master, infrastructure master, or primary domain controller (PDC) emulator. The service taking the leader role may be further enabled to extend its role by rewriting to the shared file periodically. Other services may check the file also periodically and remain passive as long as a service has currently the leader role. If the leader service is down and fails to extend its role, another service may take over by writing to the shared file ensuring a single leader in the provisioning service.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating example components of a networked system that may utilize a directory service;

FIG. 2 illustrates how a relative identity (RID) master server can be used to manage domain controllers in an example implementation;

FIG. 3 conceptually illustrates an example lock file based single leader arbitration system;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of leader arbitration for provisioning services according to embodiments.

### DETAILED DESCRIPTION

As briefly described above, a locking mechanism for provisioning services in a directory service environment may enable a service to take leader role by writing to a shared file maintained at a relative identity (RID) master server. The service taking the leader role may extend its role by rewriting to the shared file periodically. Other services may check the file also periodically and remain passive as long as a service has currently the leader role. If the leader service is down and fails to extend its role, another service may take over by writing to the shared file ensuring a single leader in the provisioning service. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing networked systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network.

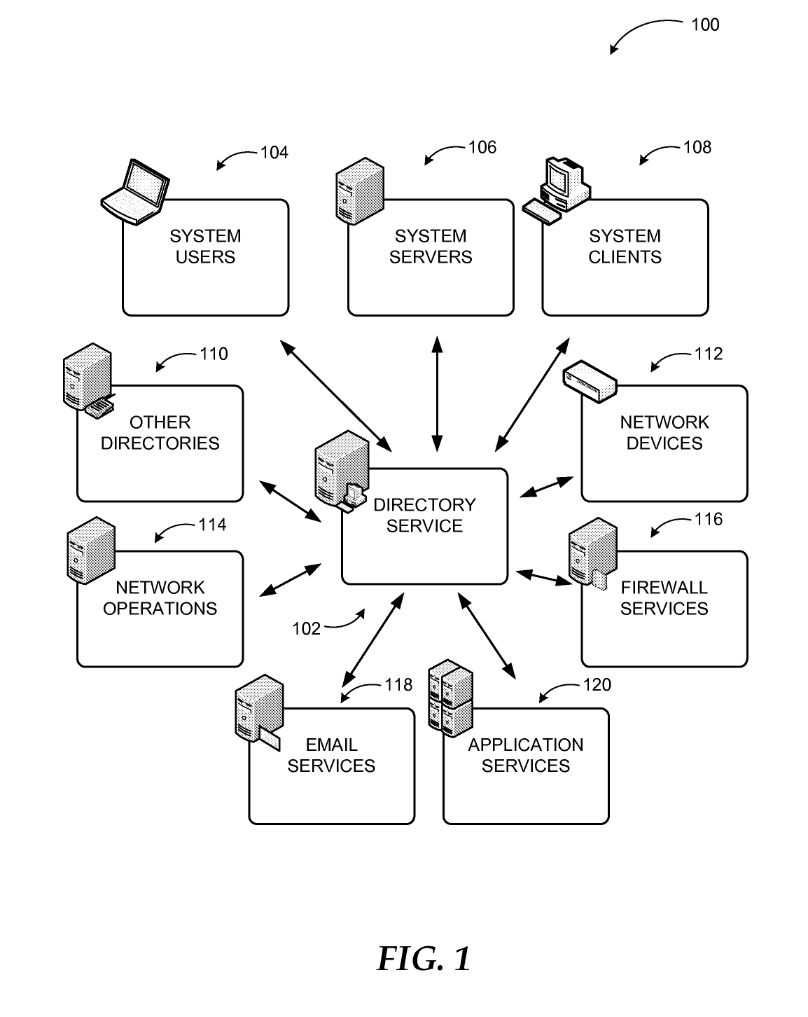

FIG. 1 is a conceptual diagram illustrating example components of a networked system that may utilize a directory service. As discussed previously, networked systems may vary in size and type, thus include a number of different components with a range of functionalities. Diagram 100 illustrates an example system with a directory service environment. The example system includes network devices 112, which may be responsible for network configuration, quality of service policies, security policies, and similar aspects. Firewall services 116 may be responsible for configuration, security policies, and virtual personal network (VPN) policies. Application services 120 may be responsible for server configurations, authorization policies (e.g. single sign-on), application specific directory information, and application policies. Email services 118 may maintain mailbox information, address books, and similar data. Network operations components 114 may maintain user registries, security policies, and similar characteristics. Other directories 110 may include specific directory servers such as white pages, e-commerce directories, and the like.

Directory service 102 may interact with all these components and facilitate assignment of policies, deployment of software, and application of updates to the organization, and similar tasks. Directory service 102 may further manage account information, privileges, profiles, and policies associated with system users 104. Directory service 102 may also interact with system servers 106, which may administer management profiles, network information, printers and similar resources, file shares, and policies. Moreover, directory service 102 may interact with system clients 108 responsible for management of their corresponding profiles and network policies.

A directory service such as Active Directory® by Microsoft Corp. of Redmond, Wash. tracks system components as objects. An object may be a user, a system, a resource, or a service tracked within the directory service. While some of the objects may share common attributes, others may have differing characteristics. Thus, a directory service structure is a hierarchical framework of objects. Each object may represent a single entity (e.g. a user, a computer, a printer, or a group) and its attributes. Certain objects may also be containers of other objects. An object may be uniquely identified by its name and have a set of attributes (e.g. the characteristics and information that the object can contain) defined by a schema, which may also determine the kind of objects that can be stored by the directory service.

Within the directory service structure, a site is an object representing a geographic location that hosts one or more networks. Sites may include objects called subnets. Sites may be used to assign group policy objects, facilitate the discovery of resources, manage active directory replication, and manage network link traffic.

A directory service framework that holds the objects may be viewed at a number of levels. At the top of the structure is the forest. A forest is a collection of every object, its attributes, and rules (attribute syntax) in the directory structure. A forest is a collection of trees and trees are a collection of one or more domains. The forest, tree, and domain are the logical parts in a directory service network. Thus, roles assigned to servers and similar components (including services) may be defined based on the hierarchical structure of the directory service. For example, a RID master server for facilitating single leader arbitration in provisioning services according to embodiments may be defined within a particular domain (and not across domains) ensuring the singleton status of the RID master.

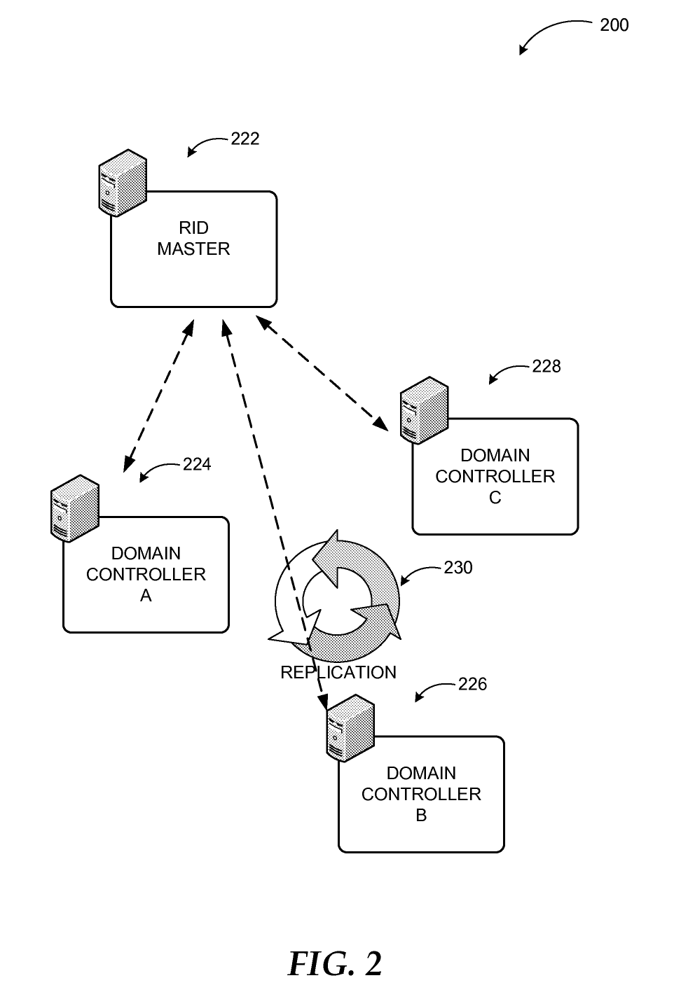

FIG. 2 illustrates how a relative identity (RID) master server can be used to manage domain controllers in an example implementation. Many services and operations may be provided within a directory service environment. Diagram 200 illustrates an example replication service among domain controllers, which is associated with a RID master server. As described below, the RID master server 222 is unique to each domain by definition. Therefore, it is employed to maintain a shared lock file according to some embodiments.

In diagram 200, different domain controllers 224, 226, and 228 replicate changes to directory service database among themselves through multi-master replication 230. However, a unique RID master server 222 is employed to assign security relative identifiers to the domain controllers 224, 226, and 228.

In a directory service structure each domain may have one or more domain controllers that include a copy of the directory service database and synchronize changes with other domain controllers (e.g. through multi-master replication). Replication is an example of services that may be facilitated within a directory service environment and occur frequently on a pull basis. A domain controller server may request updates from a fellow domain controller. If the information on one domain controller changes (e.g. a user changing their password), that domain controller may send a signal to the other domain controllers to begin a pull replication of the data to ensure they are all up-to-date.

Flexible Single Master Operations (FSMOs) are specialized domain controller tasks, used where standard data transfer and update methods are inadequate. As described above, the directory structure may normally rely on multiple peer domain controllers, each with a copy of the directory structure database, being synchronized by multi-master replication. The tasks which are not suited to multi-master replication, and are viable only with a single-master database, are the FSMOs. One example of a per-domain FSMO is the RID master. The relative identifier master may allocate security relative identifiers to domain controllers in order to assign to new directory structure security principals (e.g. users, groups or computer objects). RID master may also manage objects moving between domains.

Another example FSMO is the primary domain controller (PDC), which processes password changes in the domain. Failed authentication attempts due to a bad password at other domain controllers may be forwarded to the PDC before rejection. This ensures that a user can immediately login following a password change from any domain controller, without having to wait several minutes for the change to be replicated. A further example FSMO is the infrastructure master, which maintains security identifiers, global user identifiers (GUIDs), and domain names for objects referenced across domains. The infrastructure master may update user and group links.

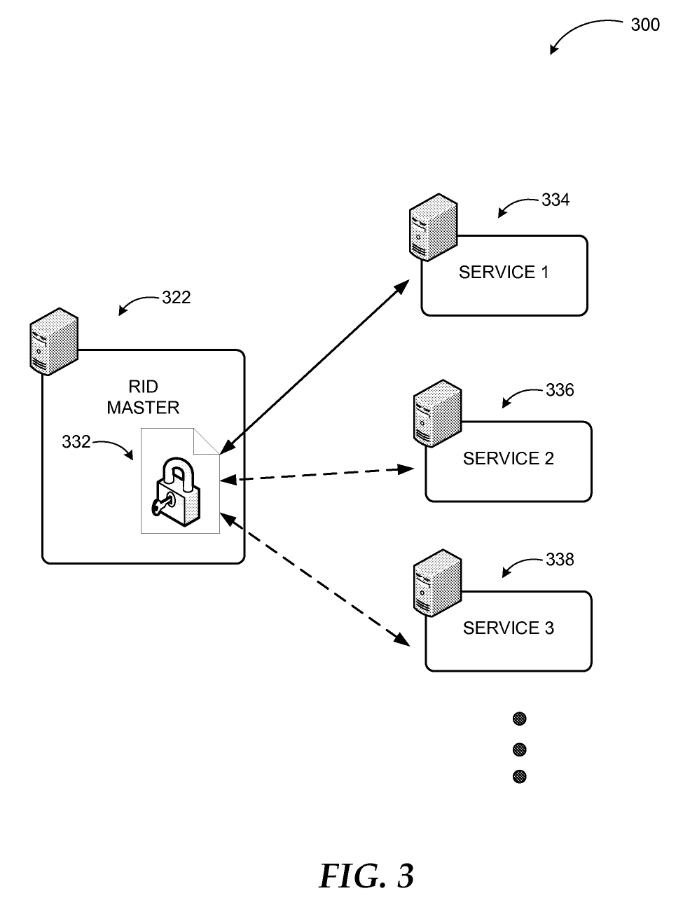

FIG. 3 conceptually illustrates an example lock file based single leader arbitration system. A locking mechanism for provisioning services in the directory service environment may be implemented by using a shared lock file 332 stored on the RID master server 322 as shown in diagram 300. RID master server 322 is a Flexible Single Master Operation (FSMO) role and there can be only one RID master server 322 for the entire domain in a directory service environment. A set of services (e.g. 334, 336, and 338) running in a domain may try to grab leadership by writing to the shared lock file 332. The first service 334 instance, which is able to grab the leadership, may extend it for a first predefined period (e.g. every X seconds). Other service instances 336, 338 may remain passive and check the leadership status after a second predefined period (e.g. every Y seconds). The second predefined period (Y) may be selected to be longer than the first predefined period (X). If Y is less than X, then a passive instance may grab the leadership before the active instance pings, which is after X time interval.

If the leader service fails, a passive service instance can grab the leadership and become active. If the RID master server 322 fails, then directory service procedures may be followed to either transfer or seize the role and make another server the RID master server 322. Both procedures guarantee that there can be only one RID master server 322. When the RID master server role is transferred or seized, the information may be transmitted to all servers in the domain as high priority following directory service practices. Thus, at any given time, the system ensures that there is a single leader. A value for Y may be chosen based on the expected worst case latency for the information to reach all the servers in the domain.

While embodiments are discussed with the example of a RID master server hosting a shared lock file, other singleton servers (physical or virtual) within each domain may also be used to maintain the lock file. For example, the PDC or infrastructure masters discussed above may host a lock file according to other embodiments.

The different processes and system configurations discussed in FIG. 1 through 3 are for illustration purposes only and do not constitute limitations on embodiments. Embodiments may be implemented with additional or fewer components (software or hardware), different configurations, and role assignments using the principles described herein.

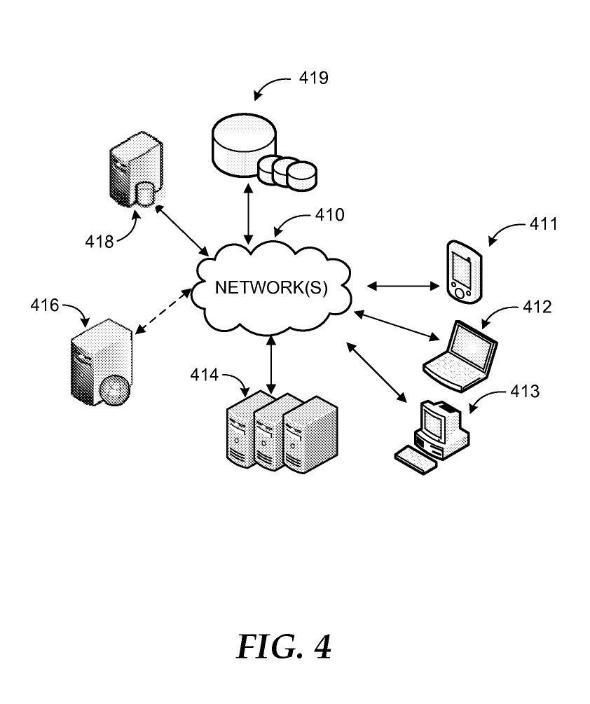

FIG. 4 is an example networked environment, where embodiments may be implemented. A platform for providing provisioning services with leadership arbitration may be implemented via software executed on server 416 such as a hosted service. The platform may communicate with other services executed on servers 414 and client applications on individual computing devices such as a smart phone 411, laptop 412, desktop computer 413, or similar devices (client devices') through network(s) 410.

Client applications executed on any of the client devices 411-413 may interact with a hosted service providing provisioning services from server 416. Other services on servers 414 may contact the provisioning service to determine a leader in the provisioning operations. The provisioning service may provide a single leader selection through a shared lock file on a RID master server and periodic confirmation of a selected leader ensuring multiple leaders are not active at any given time. Relevant data may be stored and/or retrieved at/from data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also include (especially between the servers and the mobile devices) cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform providing leader arbitration for provisioning services. Furthermore, the networked environments discussed in FIG. 4 are for illustration purposes only. Embodiments are not limited to the example applications, modules, or processes.

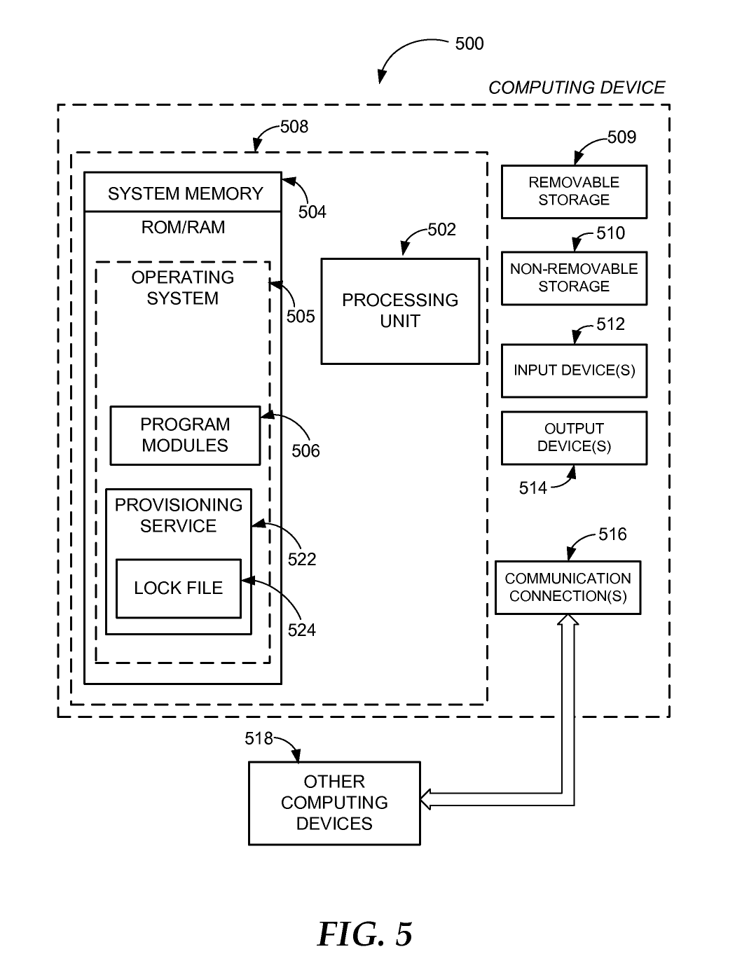

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server providing directory services according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. or similar ones. The system memory 504 may also include one or more software applications such as program modules 506, provisioning service 522 and lock file 524.

Provisioning service 522 may arbitrate requests from services within the system in a directory service environment. Upon receiving a request from a first service, provisioning service 522 may enable that service to write to shared lock file 524 indicating to other services that the first service has the leader role. The first service may also be enabled to extend its role by rewriting to the lock file 524 in predefined periods. Other services may check the file periodically and remain passive until the first service gives up its leader role. Then, another service may write to the lock file 524 and take over the leader role, and so on. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, other servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

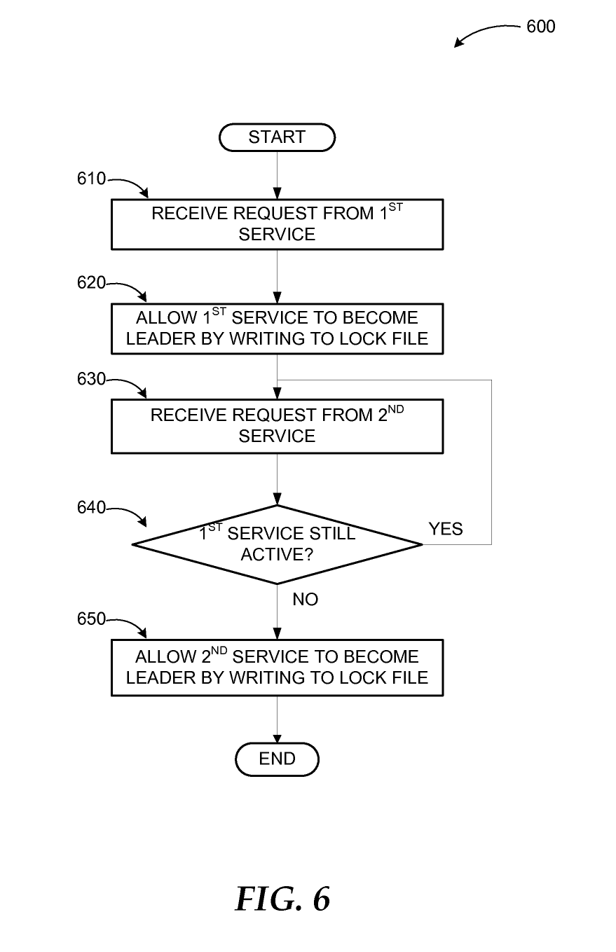

FIG. 6 illustrates a logic flow diagram for process 600 of leader arbitration for provisioning services according to embodiments. Process 600 may be implemented as part of a directory service.

Process 600 begins with operation 610, where a request is received from one of a set of services in a domain. The provisioning service may enable the requesting service to write to a lock file maintained at an RID master server and designate the requesting server as the leader at operation 620. The leader service may extend its position by periodically rewriting to the lock file.

At operation 630, the provisioning service may receive another request from another service in form of an attempt to write to the shared lock file. If the leader service's record is still in the lock file (i.e. the service is active and still the leader) as determined at decision operation 640, the provisioning service may refuse the new service to write to the lock file. That service may remain passive and check again after a predefined period. If the previous leader service is no longer active or its leadership rescinded for some reason, the provisioning service may allow the new service to write to the lock file and become the new leader at operation 650.

The operations included in process 600 are for illustration purposes. Providing leader arbitration for provisioning services may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing leader arbitration in provisioning services, the method comprising:
receiving a request from a first service;
enabling the first service to assume leader role by writing to a shared lock file;
receiving another request from a second service;
if the first service still has the leader role based on a record in the shared lock file, refusing the second service the leader role; else
enabling the second service to write to the shared lock file and assume the leader role.

2. The method of claim 1, further comprising:
enabling the first service to extend its leader role by rewriting to the shared lock file after a first predefined period.

3. The method of claim 2, further comprising:
enabling the second service to check the shared lock file after a second predefined period.

4. The method of claim 3, wherein the second predefined period is longer than the first predefined period.

5. The method of claim 3, wherein the second service remains in a passive mode if it is unable to assume the leader role.

6. The method of claim 1, wherein the shared lock file is stored at a singleton server of a domain within a directory service environment.

7. The method of claim 6, wherein the singleton server is a relative identifier (RID) master server for assigning security relative identifiers to domain controllers of the domain.

8. The method of claim 6, wherein the singleton server is one of a physical server and a virtual server.

9. The method of claim 6, further comprising:
replacing the singleton server with another singleton server;
transferring the shared lock file to the other singleton server; and
notifying servers within the domain such that the leader arbitration is continued to be facilitated through the shared lock file at the other singleton server.

10. The method of claim 1, wherein the leader arbitration is employed for resource allocation within a directory service environment.

11. A system for providing leader arbitration in provisioning services, the system comprising:
a directory server hosting a directory service, the directory service configured to:
assign a single server within a domain a leader arbitration task for resource allocation, wherein the single server maintains a shared lock file to facilitate the leader arbitration task;
a first server hosting a first service, the first service configured to:
assume leader role by writing to the shared lock file;
extend the leader role by rewriting to the shared lock file after a first predefined period; and
a second server hosting a second service, the second service configured to:
attempt to write to the shared lock file to assume the leader role;
if attempt is unsuccessful remain in a passive mode; and
re-attempt to write to the shared lock file to assume the leader role after a second predefined period.

12. The system of claim 11, wherein the directory service is further configured to:
in response to a failure of the single server, one of: transfer and seize a role of the single server;
assign the role to another single server;
transfer the shared lock file to the other single server; and
notify servers within the domain regarding the single server change.

13. The system of claim 12, wherein the second predefined period is determined based on an expected worst case latency for notification of the servers within the domain.

14. The system of claim 11, wherein the single server is one of: a relative identifier (RID) master server configured to assign security relative identifiers to domain controllers of the domain, a primary domain controller (PDC) server configured to process password changes in the domain, and an infrastructure master server configured to maintain at least one from a set of: security identifiers, global user identifiers (GUIDs), and domain names for objects referenced across domains.

15. The system of claim 14, wherein the directory service is an Active Directory service.

16. The system of claim 11, wherein the directory service is further configured to:
assign policies;
deploy software; and
apply updates to the servers within the domain.

17. The system of claim 11, wherein the first service transitions to an active mode after assuming leader role by writing to the shared lock file.

18. A computer-readable storage medium with instructions stored thereon for providing leader arbitration in provisioning services within a directory service environment, the instructions comprising:
assigning a singleton server within a domain a leader arbitration task for resource allocation, wherein the singleton server maintains a shared lock file to facilitate the leader arbitration task;
receiving a request from a first service instance;
enabling the first service instance to assume leader role by writing to the shared lock file;
receiving another request from a second service instance;
if the first service instance still has the leader role based on a record in the shared lock file, refusing the second service instance the leader role; else
enabling the second service instance to write to the shared lock file and assume the leader role.

19. The computer-readable medium of claim 18, wherein the instructions further comprise:
enabling the first service instance to extend its leadership role by rewriting to the shared lock file after a first predefined period.
enabling the second service instance to check the shared lock file after a second predefined period, wherein the second service instance remains in a passive mode if it is unable to assume the leadership role.

20. The computer-readable medium of claim 18, wherein the directory service is an Active Directory service and the singleton server includes one of: a relative identifier (RID) master server, a primary domain controller (PDC) server, and an infrastructure master server.
